(19) United States
(12) Patent Application Publication
(10) Pub. No.: US 2026/0132800 A1
(43) Pub. Date: May 14, 2026

(54) COOLING FAN SHROUD WITH HIGHLY SKEWED STATORS

(71) Applicant: Robert Bosch GmbH, Stuttgart (DE)

(72) Inventor: Yoonshik Shin, Acton, MA (US)

(21) Appl. No.: 19/375,386

(22) Filed: Oct. 31, 2025

Related U.S. Application Data
(60) Provisional application No. 63/718,332, filed on Nov. 8, 2024.

(51) Int. Cl. F04D 29/54; F04D 25/06; F04D 25/08

(52) U.S. Cl. CPC F04D 29/541; F04D 25/06; F04D 25/08

(57) ABSTRACT

A cooling fan assembly includes a fan, a motor that drives the fan, and a shroud that encloses the fan. The shroud has a plenum portion, a barrel portion, a motor-support structure and stators that span an annular region disposed between the barrel portion and the motor-support structure. The skew angle of at least one stator of the assembly is highly skewed.

### BACKGROUND

The purpose of an automotive cooling fan assembly is to draw ambient air from around a vehicle through one or more heat exchangers. A typical automotive cooling fan assembly includes a fan, a motor, and a shroud.

The shroud structure may be a one-piece injection-molded part having an air-guiding plenum portion that interfaces with a heat-exchanger, a circular barrel portion that surrounds the fan, a motor support structure, and multiple support arms (“stators”) that connect the barrel portion to the motor support structure and provide physical support to and centering of the motor support structure. In some cases, the barrel portion is a separate injection molded part that is attached to the plenum portion.

The shroud stators occupy the generally annular space between the barrel inside diameter and the outer-most portion of the motor support structure. Since the air discharged from the fan flows through this annular region, the stators have the potential to influence the aerodynamic efficiency of the fan-and-stator system. If the stators are properly designed for the environment they operate in, it is possible to improve aerodynamic efficiency by recovering energy from the flow. If the stators are not optimized for the environment, they may present an aerodynamic blockage that degrades fan aerodynamic efficiency.

As automotive vehicles evolve, under hood space for equipment, including cooling fans, continues to be reduced. Tighter under hood vehicle packaging trends have increased the amount of blockage to the fan airflow and has a deleterious effect on fan assembly efficiency. In cases where the vehicle installation creates a significant axial blockage or impediment to the fan flow field, the flow streamlines, following the path of least resistance, are forced to become more radial to get around the axial blockage. As the flow streamlines become more radial, a stator may no longer aligned with the previous more axially-oriented streamlines. This suboptimal stator to flow alignment creates an undesirable loss in aerodynamic efficiency.

There is a need for a shroud stator design that improves the aerodynamic performance of an automotive cooling fan assembly, especially when the exit streamlines have a large radial velocity component.

### SUMMARY

A cooling fan assembly includes a fan, a motor, and a shroud. The shroud is an injection-molded part having an air-guiding plenum portion that interfaces with a heat-exchanger, a circular barrel portion that surrounds the fan, a motor support structure, and multiple stators that connect the barrel portion to the motor support structure. Under some conditions, the stators described herein improve the aerodynamic performance over some prior-art stators by reducing the undesirable aerodynamic blockage effect created by surrounding stationary structures in the airflow path while providing a robust physical structure to support the motor and fan. In particular, the skew angle of at least one stator of the cooling fan assembly is highly skewed, resulting in a shroud stator design that improves the aerodynamic performance of an automotive cooling fan assembly, especially when the exit streamlines have a large radial velocity component.

This can be compared to some prior-art stators that have a thick cross-section, presenting a significant blockage effect, as well as some other prior-art stators that add additional reinforcement to increase rigidity at the expense of increased aerodynamic blockage such as circular stator-reinforcing ring. Still other prior art stators have a streamlined cross-section but are not well-aligned with the fan outflow over the at least partial shroud-barrel annular flow region.

### BRIEF DESCRIPTION OF THE FIGURES

FIG. 1 is a perspective view of a prior art cooling fan assembly.

FIG. 2 is a perspective exploded view of the cooling fan assembly of FIG. 1.

FIG. 3 is a perspective view of a prior art fan as viewed from upstream of the fan and looking downstream, illustrating the three dimensional components of velocity. The direction of fan rotation is shown by an arrow.

FIG. 4 is a front view of a prior art cooling fan assembly as viewed from upstream of the fan and looking downstream, illustrating the location of section line A-A. The direction of fan rotation is shown by an arrow.

FIG. 5 is a rear view of a prior art cooling fan assembly as viewed from downstream of the motor and looking upstream, illustrating two of the three components of velocity. The direction of fan rotation is shown by an arrow.

FIG. 6 is a cross-sectional view of the cooling fan assembly of FIG. 4 as seen along line A-A, illustrating two of the three components of velocity. The direction of fan rotation is shown by a solid line arrow, and direction of air flow is shown by a broken line arrow.

FIG. 7A is a front view of a prior art motor support as viewed from upstream of the motor support looking downstream illustrating a conventional stator sweep angle. The fan is omitted for clarity, and if shown would be rotating clockwise as shown by the narrow arrow. A wide arrow at one of the stators illustrates a local flow velocity vector.

FIG. 7B is a perspective view of a prior art motor support as viewed from upstream of the motor support looking downstream illustrating a conventional stator sweep angle. The fan is omitted for clarity, and if shown would be rotating clockwise. A wide arrow at one of the stators illustrates a local flow velocity vector.

FIG. 8A is a front view of a motor support as viewed from upstream of the motor support looking downstream illustrating an optimized stator sweep angle. The fan is omitted for clarity, and if shown would be rotating clockwise. A wide arrow at one of the stators illustrates a local flow velocity vector.

FIG. 8B is a perspective view of a motor support as viewed from upstream of the motor support looking downstream illustrating an optimized stator sweep angle. The fan is omitted for clarity, and if shown would be rotating clockwise as shown by the narrow arrow. A wide arrow at one of the stators illustrates a local flow velocity vector.

FIG. 9 illustrates cross-sections of a non-cambered stator as seen at various locations along a length of the stator, where the percentage refers to a relative distance between the stator tip (100 percent) and stator root (0 percent).

FIG. 10 illustrates cross-sections of a cambered stator as seen at various locations along a length of the stator, where the percentage refers to a relative distance between the stator tip (100 percent) and stator root (0 percent). The amount of camber is illustrated by an arrow, a mean line is shown in a dashed line and a nose-tail (“NT”) line is shown in a dotted line on the 0 percent cross section.

FIG. 11A is a front view of a motor support as viewed from upstream of the motor support looking downstream illustrating a section line A-A through a stator. Although the fan is omitted for clarity, the direction of fan rotation is shown by an arrow. In this view, the stators are optimized for a clockwise rotation of the fan.

FIG. 11B is a schematic cross-sectional view of an isolated, streamlined stator as seen along line A-A of FIG. 11A shown with reference to the central axis and illustrating a stator angle and the azimuthal location of the stator cross section. A wide arrow represents the flow field streamline direction.

FIG. 12 is a front view of a motor support as viewed from upstream of the motor support looking downstream illustrating a radial reference line shown in a dot-dashed line, a mid-chord line of the stator in a dashed line and defines sweep of the stator as corresponding to a local tangent line of the stator at the stator tip, or sweep=d(skew)/d(r).

FIG. 13A is a front view of a motor support as viewed from upstream of the motor support looking downstream illustrating a first section line A-A through a stator, a second section line B-B through the stator and a third section line C-C through the stator. The direction of fan rotation is shown by an arrow. A skew of the A-A section corresponds to an arc that extends between a radial line passing through the mid-chord of the A-A section and a radial reference line passing through the stator root mid-chord. A skew of the B-B section corresponds to an arc that extends between a radial line passing through the mid-chord of the B-B section and the radial reference line passing through the stator root mid-chord. A skew of the C-C section corresponds to an arc that extends between a radial line passing through the mid-chord of the C-C section and a radial reference line passing through the stator root mid-chord.

FIG. 13B is a schematic illustration of three cross-sections of an isolated, streamlined stator shown with reference to the central axis and illustrating skew angles and the azimuthal location of the stator cross sections. The first cross-section is as seen along line C-C of FIG. 13A, the second cross-section is as seen along line A-A of FIG. 13A and the third cross-section is as seen along line B-B of FIG. 13A.

FIG. 14 is a view of a portion of a projection of a motor support structure, a stator, and a barrel onto a plane perpendicular to the central axis as viewed from upstream of the motor support looking downstream. Although the fan is omitted for clarity, an arrow represents a direction of fan rotation. This image illustrates a mid-chord line of a stator shown in dashed lines, a first reference radial line shown in a solid line and passing through the mid-chord line at the stator root, a second reference radial line shown in solid line and passing through the mid-chord line at the stator tip, a first arc representing the average angular stator spacing and a second arc extending between the first and second reference radial lines and representing the stator tip-to-root spacing of a highly skewed stator.

FIG. 15 is a front view of a motor support as viewed from upstream of the motor support looking downstream, illustrating high-skewed stators and auxiliary support structures that cross the stators and provide reinforcement.

FIG. 16 illustrates cross-sections of a cambered stator (meridional swept view) in sections as seen at various locations along a length of the stator, where the percentage refers to a relative distance between the stator tip (100 percent) and stator root (0 percent) for a stator having a constant chord length from stator root to stator tip.

FIG. 17 illustrates cross-sections of a cambered stator (meridional swept view) as seen at various locations along a length of the stator, where the percentage refers to a relative distance between the stator tip (100 percent) and stator root (0 percent) for a stator having a chord length that increases from stator tip to stator root with reduced stagger angle.

FIG. 18 is a graph of Fluid Flow Rate (cubic meters/sec) versus Pressure (Pascals, shown in solid lines) and Static Efficiency (percentage, shown in broken lines) for a highly-skewed stator (shown in red) and a prior art stator (shown in blue).

### DETAILED DESCRIPTION

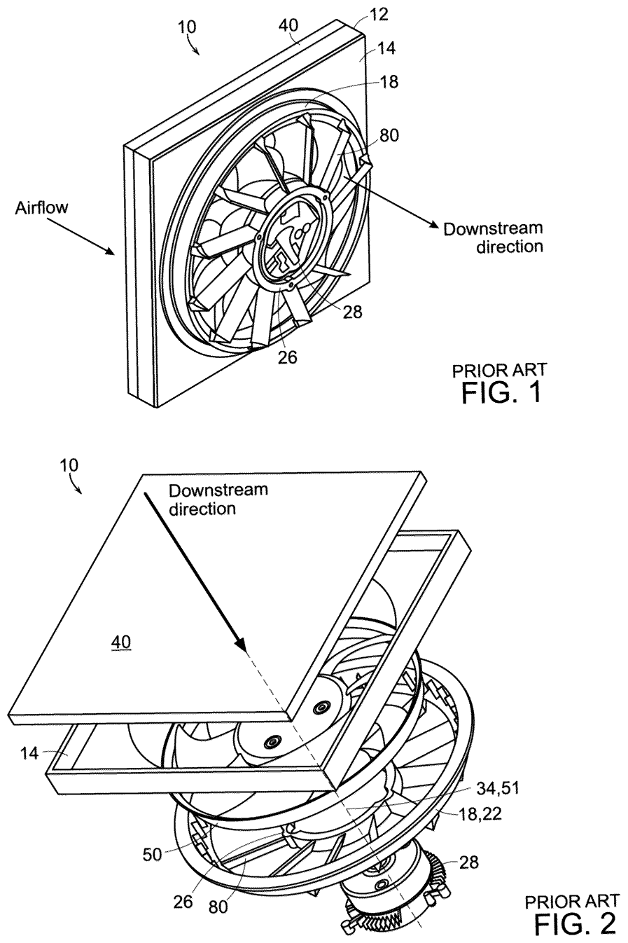

Referring to FIGS. 1 and 2, a cooling fan assembly 10 may be employed in a vehicle as part of a vehicle thermal control system that provides cooling to various components of the vehicle. The cooling fan assembly 10 includes a fan 50, an electric motor 28 that drives the fan 50, and a shroud 12. In the illustrated embodiment, the shroud 12 is an injection-molded part having an air-guiding plenum portion 14 that interfaces with a heat-exchanger (for example, a radiator) 40, a circular barrel portion 18 that surrounds the fan 50, a motor support structure 26, and multiple stators 80 that connect the barrel portion 18 to the motor support structure 26. The cooling fan assembly 10 pulls air through the radiator 40 and discharges the air in the direction indicated. The stators 80 described herein improve the aerodynamic performance of the cooling fan assembly as compared to some prior-art stators due at least in part due to their highly-skewed configuration, which reduces the undesirable aerodynamic blockage effect created by surrounding stationary structures in the airflow path. The highly-skewed stators provide a robust physical structure to support the motor and fan. The cooling fan assembly 10 including the highly-skewed stators 80 will now be discussed in detail.

The fan 50 is at least partially surrounded by the shroud barrel portion 18 and includes a plurality of blades 54 that protrude radially outward from a hub 52. In addition, the fan 50 includes a band 56 that surrounds the hub 52 and connects the tips 55 of each blade 54 so as to prevent the blades 54 from being deformed during fan operation.

The hub 52 is a hollow cylinder that is closed at one end by an end surface that is perpendicular to the fan rotational axis 51. An outer circumference of the hub 52 faces the band 56.

Each blade 54 includes a root 53 that is coupled to the band-facing surface of the hub 52, and a tip 55 that is spaced apart from the root 53. Each tip 55 is coupled to a hub-facing surface of the band 56. The air-flow directing surfaces of each blade 54 have a complex, three-dimensional curvature that is determined by the requirements of the specific application. The blade configuration, including the number of blades 54 employed by the fan 50, the shape of the blades 54, the blade spacing, etc., are also determined by the requirements of the specific application.

The hub 52, the blades 54 and the band 56 may be formed as a single piece, for example in an injection molding process. An outer surface of the band 56 is fixed to an inner surface of the barrel portion 18.

The fan 50 is rotated by rotational force transferred from the electric motor to the hub 52 via a motor shaft (not shown) that is coincident with the fan rotational axis 51. In the illustrated embodiment, the fan 50 rotates about the fan rotational axis 51 in the clockwise direction with respect to the view shown in FIG. 2, and the air flow direction, represented by the wide arrow, is parallel to the fan rotational axis 51.

The direction of the air flow that is discharged from the fan 50 is dependent at least in part on the blade curvature and includes a substantial axial flow component. As used herein, the term “axial flow component” refers to a component of air flow that flows in a direction parallel to the fan rotational axis 51.

The fan 50 is driven to rotate about a rotation axis 51 by the electric motor 28 which is mounted on the motor support structure 26. The motor support structure 26 is supported by multiple stators 80 which extend outward from the motor support structure 26 and are joined to the inner surface of the barrel portion 18 at a location that is downstream of the band 56. Thus, the motor support structure 26 and stators 80 together provide a motor support that is positioned downstream of the fan 50. Details of the structure of the stators 80 is described below.

The shroud 12 is a tubular structure that includes a flared plenum portion 14 and a cylindrical barrel portion 18 that is disposed downstream of the plenum portion 14. The plenum portion 14 facilitates the smooth entrance of air into the barrel portion 18. The barrel portion 18 is attached to the plenum portion 14 in such a way that the inner wall of the barrel portion 18 and the inner wall of the plenum portion 14 form a smooth surface. In most embodiments, the plenum portion 14 has a shape and dimensions that correspond to the shape and dimensions of the heat exchanger 40, which is often rectangular. The radial dimension of the inner surface of the upstream end of the plenum portion 14 is larger than the radial dimension of the inner surface of the barrel portion 18 whereby the shroud 12 serves to accelerate air into the cooling fan assembly 10. The shroud 12 both guides the air and contains a volume of air which is at a lower pressure than the air surrounding the shroud 12. In other embodiments, the plenum portion 14 may extend over a smaller or larger portion of the barrel portion 18, or even the entire barrel portion 18.

The barrel portion 18 may be only approximately cylindrical. When molded as a plastic part, a required draft angle may dictate that the radial dimension of the barrel 18 varies slightly along the axial extent. The sidewall 22 of the barrel is coaxial with a barrel central axis 34 and an inner diameter of the barrel sidewall 22 passes through the central axis 34. The barrel portion 18 is arranged so that the central axis 34 is coaxial with the fan rotational axis 51.

The fan 50 is supported in the shroud by the motor shaft of the electric motor 28. The electric motor 28 is mounted on the motor support structure 26. In turn, the motor support structure 26 is supported by the stators 80 which reside in the annular space between the motor support structure 26 and the barrel portion 18.

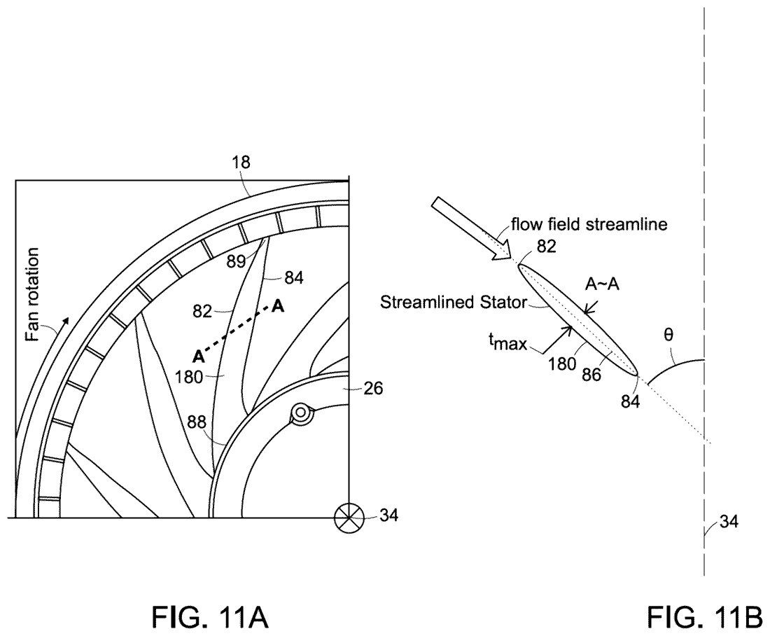

Referring to FIGS. 11A and 11B, each stator includes a leading edge (or “nose”) 82 and a trailing edge (or “tail”) 84. Each stator 80 includes a stator root 88 corresponding to the location at which the stator 80 terminates at the outer surface of the motor support structure 26. Each stator 80 includes a stator tip 89 corresponding to the location at which the stator 80 terminates at the inner surface of the barrel portion 18.

The cross section of each stator 80 has an aerodynamic shape. As used herein, the term “Aerodynamic Shape” refers to a streamlined shape, a shape designed to minimize drag associated with the fluid flowing around the shape. In particular, a cross-section of an aerodynamic stator 80 will have an axis of symmetry along its longer length dimension that ends at the nose 82 upstream and at the tail 84 downstream. A chord line (or “nose-tail (NT) line) 86 corresponds to a straight line that extends between the nose 82 of the stator 80 and the tail 84 of the stator 80. The chord line 86 has a chord length c which is the length of the chord line 86.

In the illustrated embodiment, the chord length c is approximately 6 times larger than the maximum thickness tₘₐₓ. The stator leading edge 82 is rounded, and the thickness at the stator trailing edge 84 is less than the maximum thickness tₘₐₓ. The size and shape of a given stator 80 may reduce the severity of the viscous wake downstream of the stator, and thereby decrease the drag of the stator and reduce the noise generated when a fan blade 54 moves through the wake.

Referring again to FIGS. 1 and 2, the degree of parasitic blockage presented by the stators 80 is related to the cross-sectional shape of the stator 80 and its alignment with the surrounding airflow streamlines exiting the fan 50. These streamlines are also affected by the presence of downstream objects where the closer an object is to the stators 80, the greater the influence the object has on the streamline trajectory.

The fan 50, the electric motor 28 and the shroud barrel portion 18 share a common central axis 34. The orientation of the central axis 34 identifies the up/down stream directions where upstream refers to locations along the central axis 34 where the airflow has not yet entered the fan 50 and downstream refers to locations along the central axis 34 where the airflow has travelled through the fan 50.

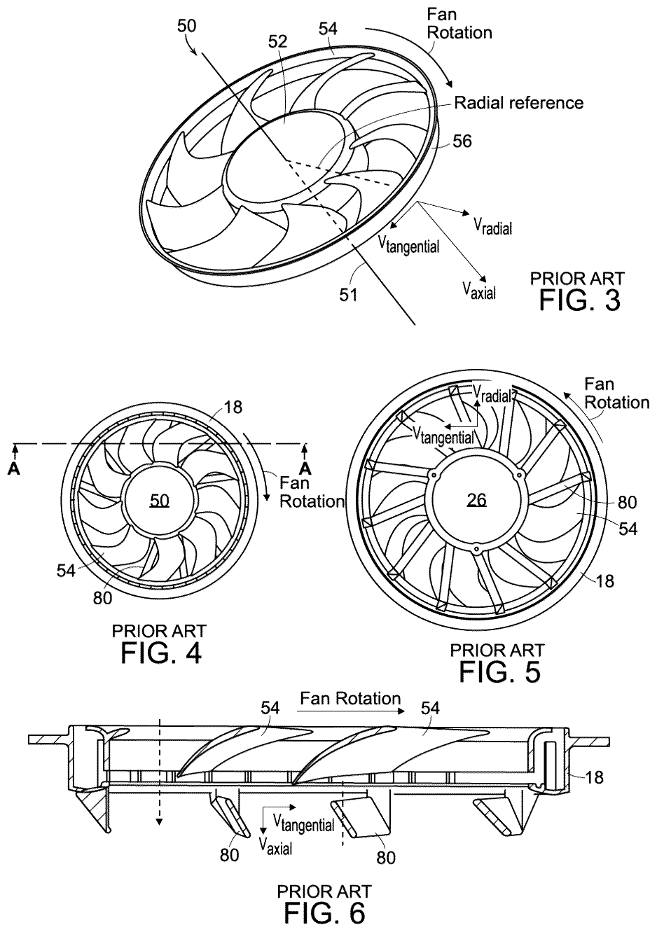

Referring to FIGS. 3-6, the flow field downstream of the fan 50 is three dimensional and varies from point to point in the domain. The velocity at any point in the flow field can be characterized by three (3) orthogonal velocity components, axial, radial, and tangential. Axial velocity is parallel to the central axis 34, radial velocity is perpendicular to the central axis 34 and directed outward away from the central axis 34, and tangential velocity is directed in the azimuthal coordinate. The rotating fan 50 imparts axial, radial, and tangential velocity at the fan exit. The imparted tangential velocity is in the same direction as the fan's rotation.

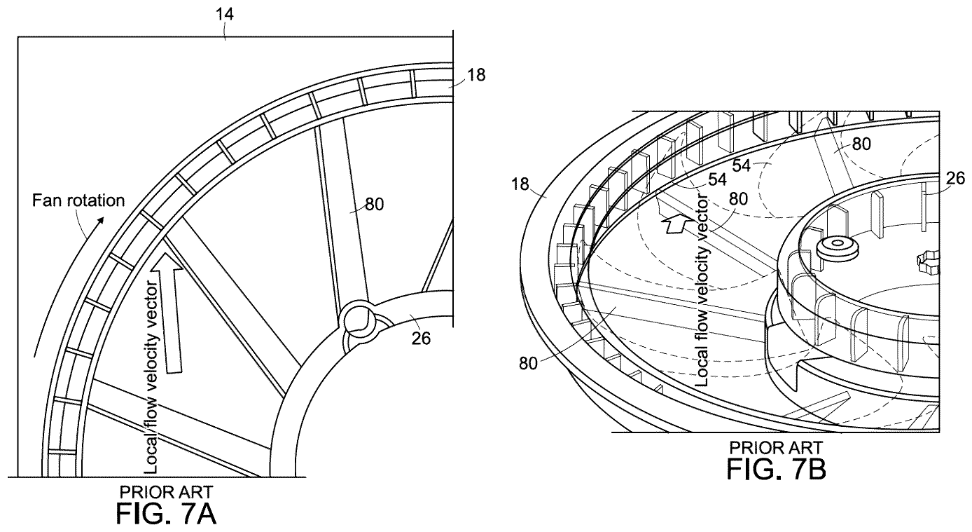

Referring to FIGS. 7A and 7B, the velocity downstream of the fan 50 is a function of the fan's design, its operating point, and any object(s) in the flow domain that present a blockage to the flow. Any object that blocks or impedes the flow from the fan, has the potential to reduce the aerodynamic efficiency of the fan system. Since the motor-support stators 80 are positioned downstream of, and in close proximity to, the fan 50, the stators 80 have the potential to influence the aerodynamic efficiency of the fan-stator system.

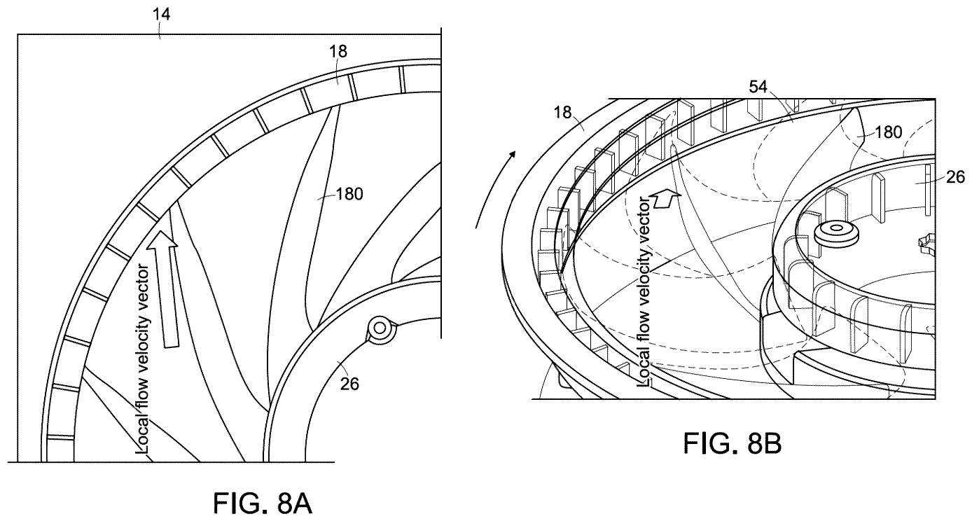

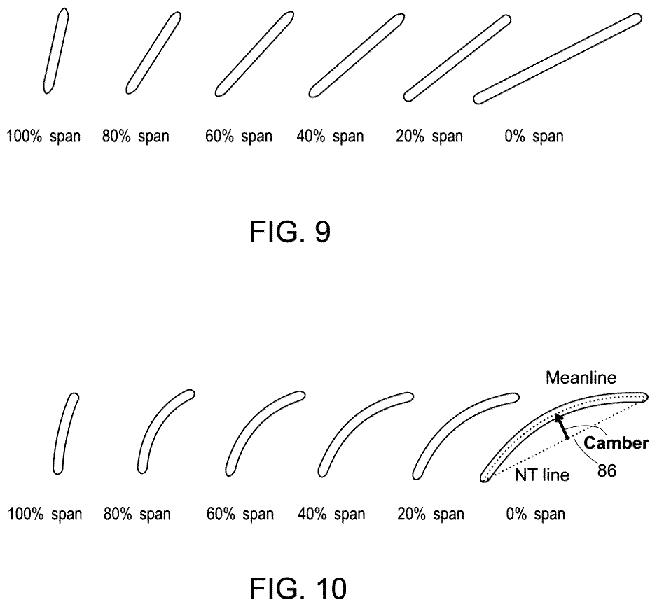

Referring to FIGS. 8A, 8B and 9, performance degrading blockage created by the stators 80 can be minimized by using streamlined stator cross sections and aligning these streamlined cross-sections with the local flow-field velocity along the spanwise stator coordinate, e.g., along the stator at locations between the stator root 88 and the stator tip 89.

A streamlined cross section is one which is designed to present a minimum resistance, or drag, to the oncoming flow when the section is aligned with the flow. Streamlined cross sections can typically be described as having a long axis which is parallel to the flow direction and a shorter axis which is at a cross-angle to the oncoming flow direction. The long axis is typically an axis of symmetry. For best performance, the ratio of the longer-axis to the shorter-axis should be kept as high as practical but at least 3:1.

The spanwise stator coordinate can be expressed as a percentage of the total span (e.g., radial dimension) between the outer surface of the motor support structure 26 and the inner surface of the barrel portion 18, where the stator root 88 corresponds to 0 percent of overall span dimension and the stator tip 89 corresponds to 100 percent.

Referring to FIG. 10, in some cases, additional aerodynamic efficiency gains may be possible by recovering some energy from the air flowing past the stators by adding camber to the cross-section. Under some conditions, lift can be generated from a streamlined shape by adding camber to the section. As used herein, the term “camber” refers to a measure of the curvature of a shape. In the context of a stator aerodynamically shaped cross-section, the camber can be quantified as the distance from the nose-tail line to the mean line.

Adding camber to a streamlined cross section is adding curvature to the “long axis” while maintaining the long axis equidistant to the section boundaries on either side of the curved line. Since this curved line is in the middle of the section thickness is called the “mean line” of the section. If a section has zero camber, the mean line is colinear with the nose-tail line.

When a streamlined cross-section is not aligned with the incoming flow, as long as the angular departure is within a few degrees, the increase in drag is considered “small”.

An aerodynamic cross section is one which is designed to generate lift while minimizing drag. The lift may come from the section having an angle of attack to the oncoming flow or from adding chamber to the cross section.

Referring to FIGS. 11A and 11B, as the flow field streamlines becomes more radial, it is possible to design a stator to minimize the efficiency-degrading blockage effect by optimizing both a stator's stagger angle and sweep angle. As used herein the term “stagger angle” refers to an angular measurement that describes the angle the strut/stator/support member cross-section axis makes with a line parallel to the central axis. The stagger angle Θ can be defined in a horizontal plane as the angle between the local stator NT line 86 and the central axis 34. A stagger angle Θ of zero degrees means the angle of the stator nose-tail line 86 is parallel to the central axis 34.

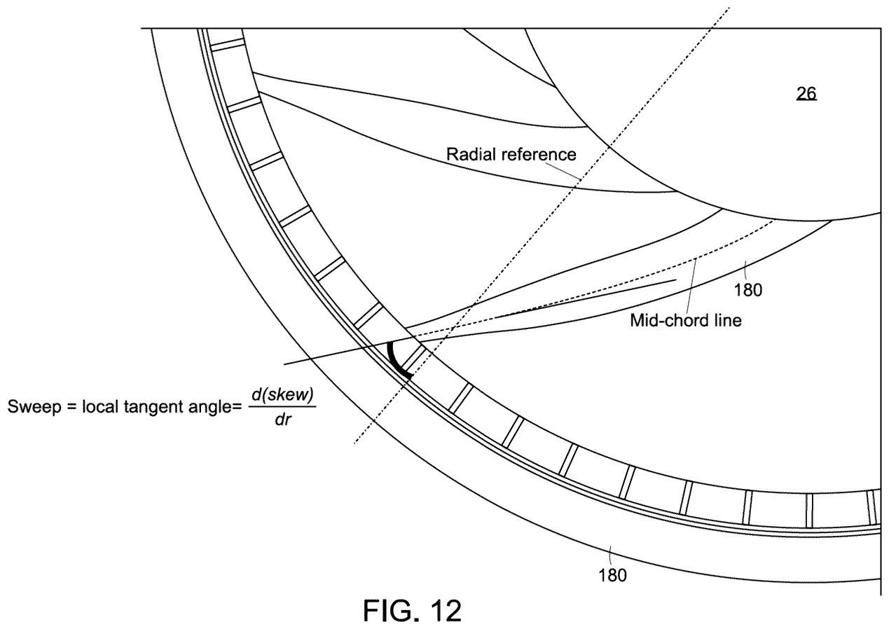

Referring to FIGS. 9 and 12, as used herein, the term “Sweep Angle” refers to an angular measurement describing the slope of the stator's skew. Sweep=d(skew)/dr where r is the radial dimension. The sweep angle can be defined in a plane perpendicular to the central axis 34 as the local slope of the stator skew. In equation form, sweep=d_skew/d_radius.

Since the flow field is three-dimensional, the optimization is a function of the stator's 80 spanwise coordinate (FIG. 9) and the stator optimization may vary from stator to stator within a set of stators.

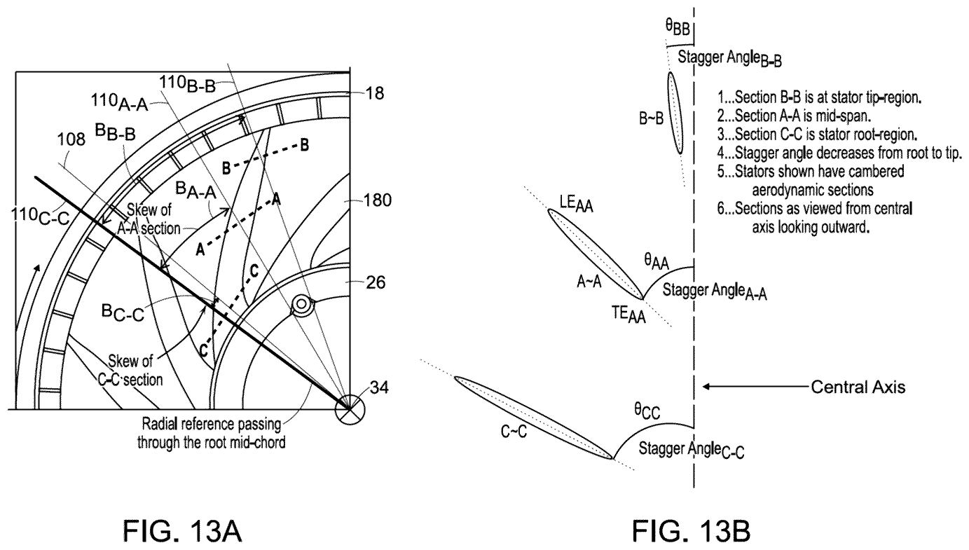

Referring to FIGS. 13A-13B, the azimuthal location of each stator 80 can be defined in a plane perpendicular to the central axis 34. The reference angle for the stator 80 is a first radial line 108 extending from the central axis 34 and intersecting the midpoint of the stator root section NT line. For each spanwise section, a second radial line 110 is defined from the central axis that intersects the local sections NT line midpoint. The angle between these two radial lines is the skew angle β.

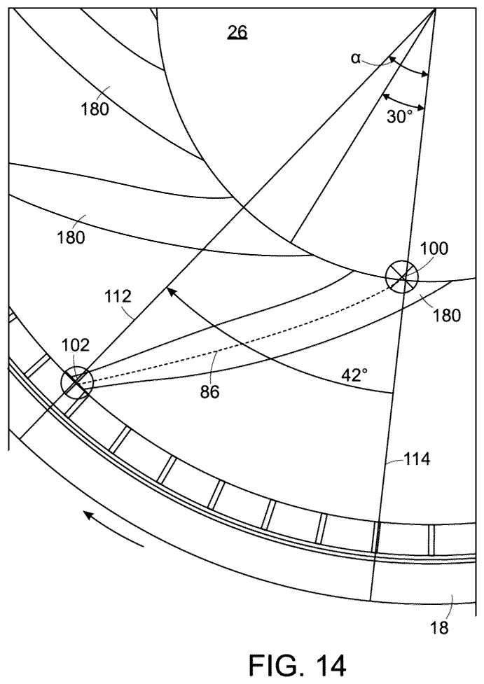

Referring to FIG. 14, the skew angle α between a radial line 112 that intersects the stator tip section's nose-tail line midpoint (e.g., an outer terminus point 102) and a radial line 114 that intersects the stator root section's nose-tail line midpoint (e.g., an inner terminus point 100) is also referred to as the stator's azimuthal extent and is measured in degrees.

The average angular spacing between stators is defined as 360-degrees divided by the number of stators. For example, a shroud barrel with 10-stators would have an average angular spacing of 36 degrees.

In some embodiments, the term “highly skewed” refers to a stator 180 having a skew angle α that is at least equal to a stator average angular spacing. In some embodiments, a highly skewed stator corresponds to a stator 180 in which the skew angle α is at least 70 percent of the stator average angular spacing. In some embodiments, a highly skewed stator corresponds to a stator 180 in which the skew angle α is at least 80 percent of the stator average angular spacing. In some embodiments, a highly skewed stator corresponds to a stator 180 in which the skew angle α is at least 90 percent of the stator average angular spacing.

FIG. 14 illustrates a stator 180 that is highly skewed such that the skew angle α of the at least one stator is at least equal to a stator average angular spacing. In this embodiment, the angular displacement from the inner-terminus point 100 to the outer-terminus point 102 is in same angular direction as a rotation direction of the fan 50. The skew angle α of the stator 180 is defined between the first radial line 112 and the second radial line 114, and in this example the skew angle α is 42 degrees. In this embodiment, the average angular stator spacing is 30 degrees, whereby the stator 180 is highly skewed.

In the embodiment illustrated in FIG. 14, all of the stators 180 are highly skewed. However, in other embodiments, a subset of the stators employed in the assembly 10 may be highly skewed while the remaining stators are normally skewed or without skew.

Referring again to FIGS. 7A and 8A, as discussed above, the presence of downstream axial blockage will affect the fan's exiting streamlines by reducing the axial component of the velocity and increasing the radial component of velocity. To optimize a stator for this blockage condition, the importance of stagger angle becomes less important while the importance of sweep angle becomes more important. Under these conditions overall stator optimization will favor a stator with reduced stagger angle and an increased sweep angle.

Under some conditions, additional aerodynamic efficiency can be achieved by adding chamber to the stator cross section (FIG. 10).

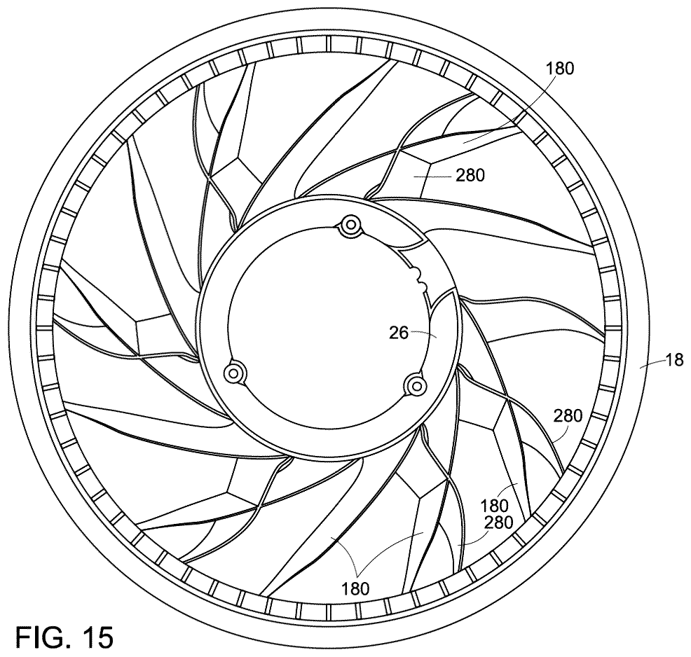

Referring to FIG. 15, as the stator stagger decreases, and as the stator sweep angle becomes more extreme, the mechanical stiffness of the stator 180 is reduced. This reduced stiffness can be offset by adding a stator 280 that intersects the stator 180 with reduced stagger and increased sweep.

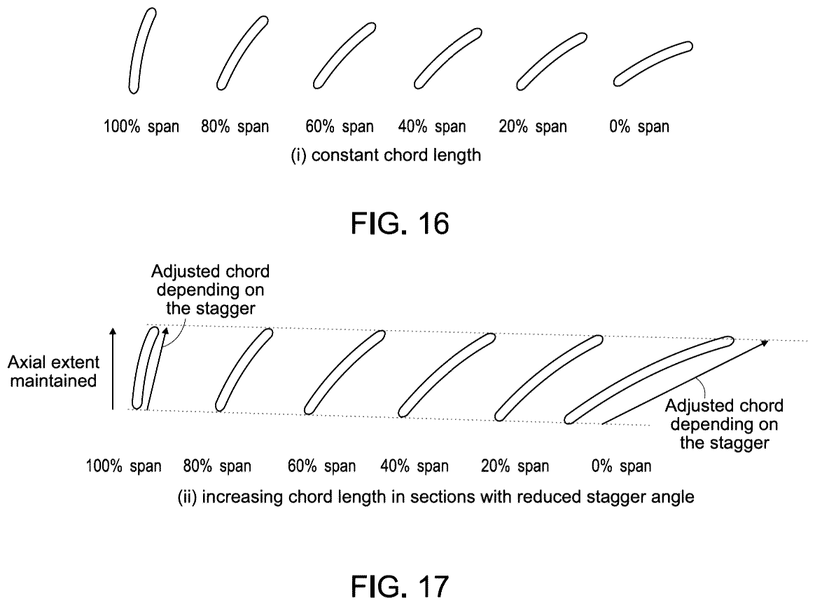

Referring to FIGS. 16-18, another way to increase the stator stiffness is to increase the axial extent of the stator 180. If the chord length of the stator sections is fixed, as the stator stagger angle increases, the axial extent of the stator 180 decreases which in turn reduces the axial stiffness. This loss in axial stiffness can be offset by increasing the chord length of the stator section.

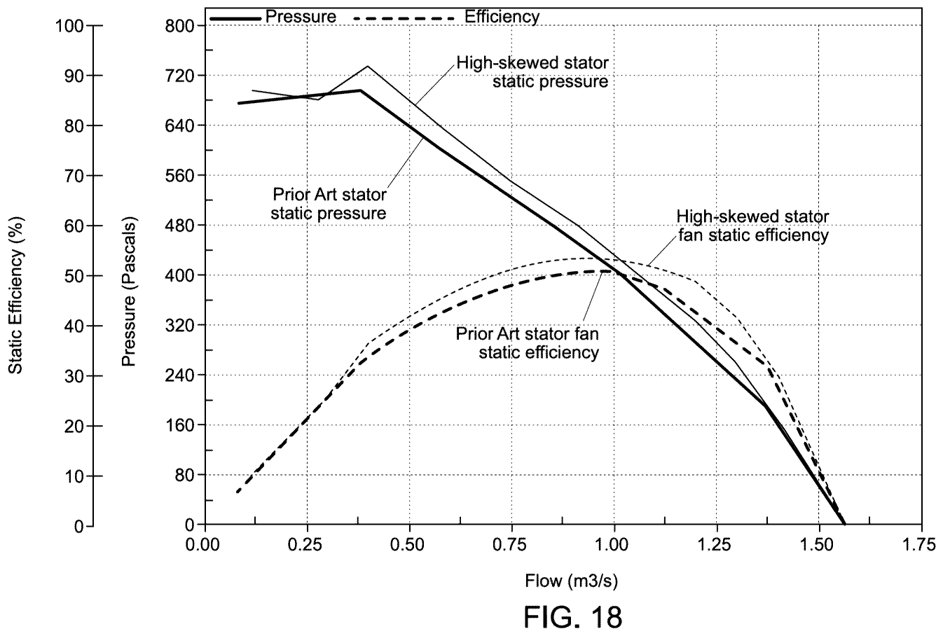

When the stator 180 has been optimized for the axial blockage condition as described above, its aerodynamic efficiency will be improved. FIG. 18 shows the fan performance of an automotive cooling fan assembly in an axial blockage environment with prior-art stators compared to an assembly using optimized highly skewed stators.

A selective illustrative embodiment of the cooling fan assembly including a highly skewed stator is described above in some detail. It should be understood that only structures considered necessary for clarifying the assembly have been described herein. Other conventional structures, and those of ancillary and auxiliary components of the assembly, are assumed to be known and understood by those skilled in the art. Moreover, while a working example of the assembly has been described above, the assembly is not limited to the working example described above, but various design alterations may be carried out without departing from the assembly as set forth in the claims.

What is claimed, is:

1. A cooling fan assembly, comprising:
a shroud that includes
an air-guiding plenum,
a hollow, cylindrical barrel having a sidewall centered on a barrel axis, the sidewall having an inner diameter,
a motor-support structure, and
stators that span an annular region disposed between the barrel portion and the motor-support structure;
a motor supported by the motor support structure, the motor having a motor shaft that defines a central axis, the central axis being coincident with the barrel axis; and
a fan that is at least partially surrounded by the barrel, the fan including
a hub that driven to rotate by the motor and centered on the central axis, and
blades that protrude from the hub and are arrayed around the central axis;
wherein
a projection-plane can be drawn perpendicular to the central axis and the projection-plane is upstream of the barrel-portion of the shroud,
when the stators, the motor-support structure, and the barrel are projected onto the projection plane, the projection of at least one of the stators on the projection-plane corresponds to a first stator line that extends between the motor support structure and the barrel sidewall and a second stator line that extends between the motor support structure and the barrel sidewall, and a mid-chord line that is disposed between the first stator line and the second stator line and is equidistant from each of the first stator line and the second stator line,
the chord line of the at least one of the stators intersects the projection of an inner diameter of the barrel at an outer-terminus point and intersects the projection of an outer portion of the motor-support structure at an inner-terminus point,
angular displacement from the inner-terminus point to the outer-terminus point is in same angular direction as a rotation direction of the fan,
a skew angle of the at least one stator is defined between a first radial line and a second radial line, and
the skew angle of the at least one stator is at least equal to a stator average angular spacing, where
the first radial line extends from the central axis to the outer-terminus point and the second radial line extends from the central axis to the inner-terminus point, and
the stator average angular spacing corresponds to 360 degrees divided by the number of stators employed in the automotive cooling fan assembly.

2. The cooling fan assembly of claim 1, wherein the skew angle of the at least one stator is at least 70% of the stator average angular spacing.

3. The cooling fan assembly of claim 1, wherein the skew angle of the at least one stator is at least 80% of the stator average angular spacing.

4. The cooling fan assembly of claim 1 wherein skew angle of the at least one stator is at least 90% of the stator average angular spacing.

5. The cooling fan assembly of claim 1, wherein at least one the stator has an aerodynamic cross-section.

6. The cooling fan assembly of claim 5, wherein a chord length of the cross section of the at least one stator is increased in regions where the stagger angle is increased.

7. The cooling fan assembly of claim 1, wherein the at least one stator has a varying stagger angle along a chord line of the at least one stator.

8. The cooling fan assembly of claim 1, wherein the at least one stator has a decreasing stagger angle from a mid point of a chord line of the at least one stator to the point at which the chord line intersects the barrel.

9. The cooling fan assembly of claim 1, wherein a cross section of the at least one stator has camber.

10. The cooling fan assembly of claim 1, wherein the at least one stator intersects with an auxiliary support structure that is configured to support the at least one stator.

11. The cooling fan assembly of claim 10, wherein the auxiliary support structure has an inner terminus at the motor-support structure and an outer terminus at the shroud barrel.

12. The cooling fan assembly of claim 1, wherein a mid-region of the at least one stator is mechanically connected to a mid-region of another stator.

13. The cooling fan assembly of claim 12, wherein the another stator has a skew angle that is different than a skew angle of the at least one stator.

14. The cooling fan assembly of claim 12, wherein the at least one stator intersects with another stator at a location spaced apart from both a tip of the at least one stator and a root of the at least one stator.
